(19) United States
(12) Patent Application Publication
(10) Pub. No.: US 2011/0184798 A1
(43) Pub. Date: Jul. 28, 2011

(54) COMMODITY INFORMATION PROCESSING SYSTEM, PORTABLE TERMINAL, AND COMPUTER PROGRAM

(75) Inventors: Yun Wang, Kanagawa (JP); Keiichi Hasegawa, Tokyo (JP); Kenji Terasaki, Chiba (JP)

(73) Assignee: TOSHIBA TEC KABUSHIKI KAISHA, Tokyo (JP)

(21) Appl. No.: 13/013,072

(22) Filed: Jan. 25, 2011

(30) Foreign Application Priority Data
Jan. 26, 2010 (JP) 2010-014608

(51) Int. Cl. G06Q 30/00

(52) U.S. Cl. 705/14.38; 705/23; 705/20

(57) ABSTRACT

According to one embodiment, a commodity information processing system includes a second reading unit, a medium issue unit, a first storing unit having sale-in-a-set information stored therein, a specific-information generating unit, a determining unit, and an issue unit. The specifying information generating unit generates provisionally-registered commodity specifying information for specifying a commodity, commodity identification information of which is read by the second reading unit. The issue unit causes, if the determining unit determines that the commodity, the commodity identification information of which is read by the second reading unit, is a target commodity of the sale in a set, the medium issue unit to issue an information display medium on which sale-in-a-set information including the commodity as the target commodity and stored in the first storing unit and the provisionally-registered commodity specifying information are displayed.

### CROSS-REFERENCE TO RELATED APPLICATION

This application is based upon and claims the benefit of priority from the prior Japanese Patent Application No, 2010-014608, Jan. 26, 2010 the entire contents of which are incorporated herein by reference.

### FIELD

Embodiments described herein relate generally to a commodity information processing system, a portable terminal, and a commodity information processing method.

### BACKGROUND

In the past, as a commodity information processing system for a store such as a supermarket, for example, there has been a commodity information processing system in which a provisional registration system is incorporated in a checkout system including a POS terminal. The provisional registration system provisionally registers in advance information concerning a commodity to be subjected to checkout processing in a POS terminal set in a checkout area of a store. In the provisional registration system, first, a store clerk operates a portable terminal carried by the store clerk to convert information concerning a commodity to be purchased by a customer into electronic data and provisionally registers the commodity. The portable terminal converts the information concerning the commodity to be purchased into a code on the basis of the electronic data of the provisionally-registered commodity and causes a printer to issue a provisional receipt on which the code is printed (see, for example, Japanese Patent No. 3632019)

A customer passes the provisional receipt to a cashier in the checkout area of the store. The cashier causes a scanner connected to the POS terminal to read the code printed on the provisional receipt. The POS terminal executes the checkout processing on the basis of the data of the code read by the scanner.

When the commodity is provisionally registered by the portable terminal before the checkout processing in the POS terminal, it is possible to efficiently perform the checkout processing and reduce checkout time.

In a store, when items of a commodity determined in advance are purchased together, in some case, sale in a set for selling the commodity at a discount is performed (see, for example, JP-B-6-36234). The sale in a set has an advantage that it is possible to arouse a customer's desire to purchase items of a commodity enough for realizing the sale in a set and achieve sales promotion for the commodity.

However, when the sale in a set is not realized, before settlement, information concerning the sale in a set is not notified to a customer who purchases the commodity.

### DESCRIPTION OF THE DRAWINGS

FIG. 1 is a diagram of a schematic configuration of a commodity information processing system according to a first embodiment;

FIG. 2 is a perspective view of a portable terminal according to the first embodiment viewed from the front surface side thereof;

FIG. 3 is a perspective view of the portable terminal according to the first embodiment viewed from the rear surface side thereof;

FIG. 4 is a plan view of a key unit of the portable terminal according to the first embodiment;

FIG. 5 is a diagram of a schematic configuration of the portable terminal according to the first embodiment;

FIG. 6 is an explanatory diagram for explaining a provisionally-registered commodity information storage area formed in a RAM of the portable terminal according to the first embodiment;

FIG. 7 is a diagram of a schematic configuration of a POS terminal according to the first embodiment;

FIG. 8 is a diagram of a schematic configuration of a store server according to the first embodiment;

FIG. 9 is a diagram of a functional configuration of a CPU of the portable terminal according to the first embodiment;

FIG. 10 is a flowchart for explaining a flow of provisional registration processing performed by the portable terminal and the store server according to the first embodiment;

FIG. 11 is a plan view of a provisional receipt according to the first embodiment;

FIG. 12 is a diagram of a functional configuration of a CPU of the POS terminal according to the first embodiment;

FIG. 13 is a flowchart for explaining a flow of checkout processing performed by the CPU of the POS terminal according to the first embodiment;

FIG. 14 is a diagram of a functional configuration of a CPU of a portable terminal according to a second embodiment; and

FIG. 15 is a flowchart for explaining operations performed by a commodity information processing system according to the second embodiment.

### DETAILED DESCRIPTION

An embodiment makes it possible to cause, if a commodity to be provisionally registered is a target commodity of sale in a set, a customer to recognize information concerning the sale in a set before settlement.

In general, according to one embodiment, a commodity information processing system includes a second reading unit, a medium issue unit, a first storing unit having sale-in-a-set information stored therein, a specific-information generating unit, a determining unit, and an issue unit. The second reading unit is provided separately from a first reading unit provided in a settlement apparatus. The second reading unit reads commodity identification information attached to a commodity. The medium issue unit issues an information display medium on which information is displayed. The first storing unit has stored therein sale-in-a-set information including commodity identification information concerning a target commodity in sale in a set for granting a benefit by selling plural items of a commodity together in one transaction, information concerning a condition for realizing the sale in a set, and information concerning the benefit. The specifying information generating unit generates provisionally-registered commodity specifying information for specifying the commodity, the commodity identification information of which is read by the second reading unit. The determining unit searches through the first storing unit for the commodity identification information read by the second reading unit and determines whether the commodity, the commodity identification information of which is read, is a target commodity of the sale in a set. The issue unit causes, if the determining unit determines that the commodity, the commodity identification information of which is read, is a target commodity of the sale in a set, the medium issue unit to issue the information display medium on which the sale-in-a-set information including the commodity as the target commodity and stored in the first storing unit and the provisionally-registered commodity specifying information are displayed.

According to another embodiment, a portable terminal includes a reading unit, a storing unit, a storage control unit, a converting unit, and an output unit. The reading unit reads commodity identification information attached to a commodity. The storing unit stores the commodity identification information read by the reading unit. The storage control unit causes, if information corresponding to the commodity identification information read by the reading unit, which is information concerning a condition for realizing sale in a set for granting a benefit by selling plural items of a commodity together in one transaction, is present, the storing unit to store the information concerning the condition for realizing the sale in a set. The converting unit converts a plurality of pieces of the commodity identification information into pieces of information of different formats. The output unit outputs at least the converted plural pieces of commodity identification information and the information concerning the condition for realizing the sale in a set.

According to still another embodiment, a commodity information processing method is a commodity information processing method executed by a commodity information processing system including: a second reading unit provided separately from a first reading unit, which is provided in a settlement apparatus, and configured to read commodity identification information attached to a commodity; a medium issue unit configured to issue an information display medium on which information is displayed; and a first storing unit having stored therein sale-in-a-set information including commodity identification information concerning a target commodity in sale in a set for granting a benefit by selling plural items of a commodity together in one transaction, information concerning a condition for realizing the sale in a set, and information concerning the benefit. The method includes: a specifying information generating unit generating provisionally-registered commodity specifying information for specifying the commodity, the commodity identification information of which is read by the second reading unit; a determining unit searching through the first storing unit for the commodity identification information read by the second reading unit and determining whether the commodity, the commodity identification information of which is read, is a target commodity of the sale in a set; and an issue unit causing, if the determining unit determines that the commodity, the commodity identification information of which is read, is a target commodity of the sale in a set, the medium issue unit to issue the information display medium on which the sale-in-a-set information including the commodity as the target commodity and stored in the first storing unit and the provisionally-registered commodity specifying information are displayed.

According to still another embodiment, a commodity information processing method is a commodity information processing method executed by a portable terminal including: a reading unit configured to read commodity identification information attached to a commodity; and a storing unit configured to store the commodity identification information read by the reading unit. The method includes: a storage control unit causing, if information corresponding to the commodity identification information read by the reading unit, which is information concerning a condition for realizing sale in a set for granting a benefit by selling plural items of a commodity together in one transaction, is present, the storing unit to store the information concerning the condition for realizing the sale in a set; a converting unit converting a plurality of pieces of the commodity identification information into pieces of information of different formats; and an output unit outputting at least the converted plural pieces of commodity identification information and the information concerning the condition for realizing the sale in a set.

Exemplary embodiments of a commodity information processing system, a portable terminal, and a commodity information processing method will be explained below in detail with reference to the accompanying drawings. Plural embodiments explained below include the same components. Therefore, in the following explanation, the same components are denoted by the same reference numerals and signs and redundant explanation of the components is omitted.

### First Embodiment

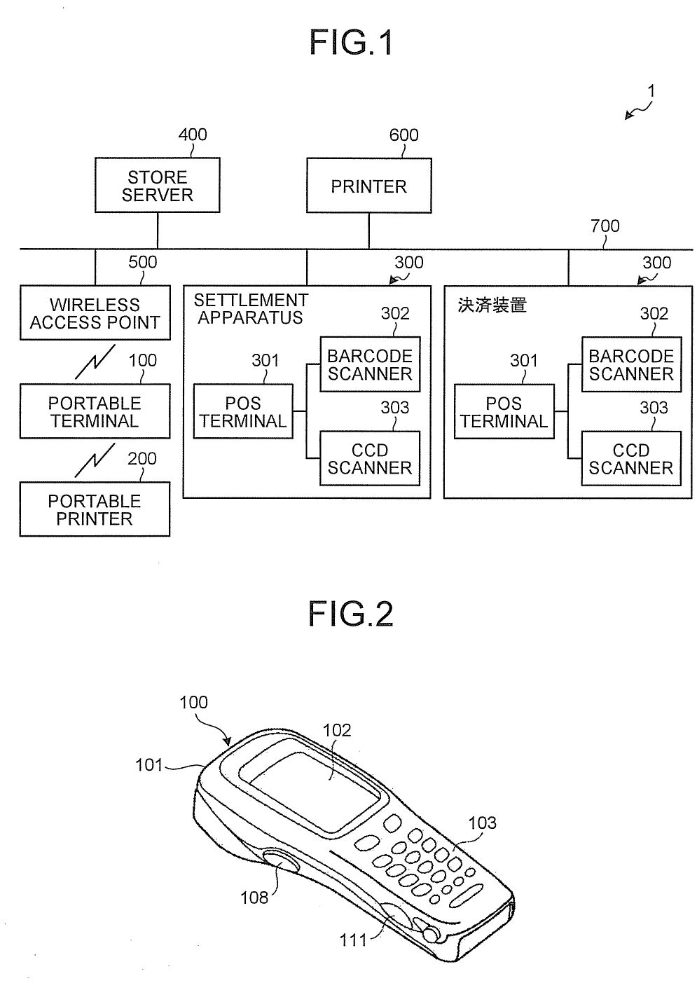

First, a first embodiment is explained with reference to FIGS. 1 to 13. As shown in FIG. 1, a commodity information processing system 1 includes a portable terminal 100, a portable printer 200 as a media issue unit, settlement apparatuses 300, a store server 400 as a server, a wireless access point 500, and a printer 600. The settlement apparatuses 300, the store server 400, the wireless access point 500, and the printer 600 are connected by a wired communication network 700 such as a wired local area network (LAN). The portable terminal 100 is connected to the wireless access point 500 and the portable printer 200 by wireless communication. In this embodiment, the portable terminal 100, the portable printer 200, and the store server 400 configure a provisional registration system.

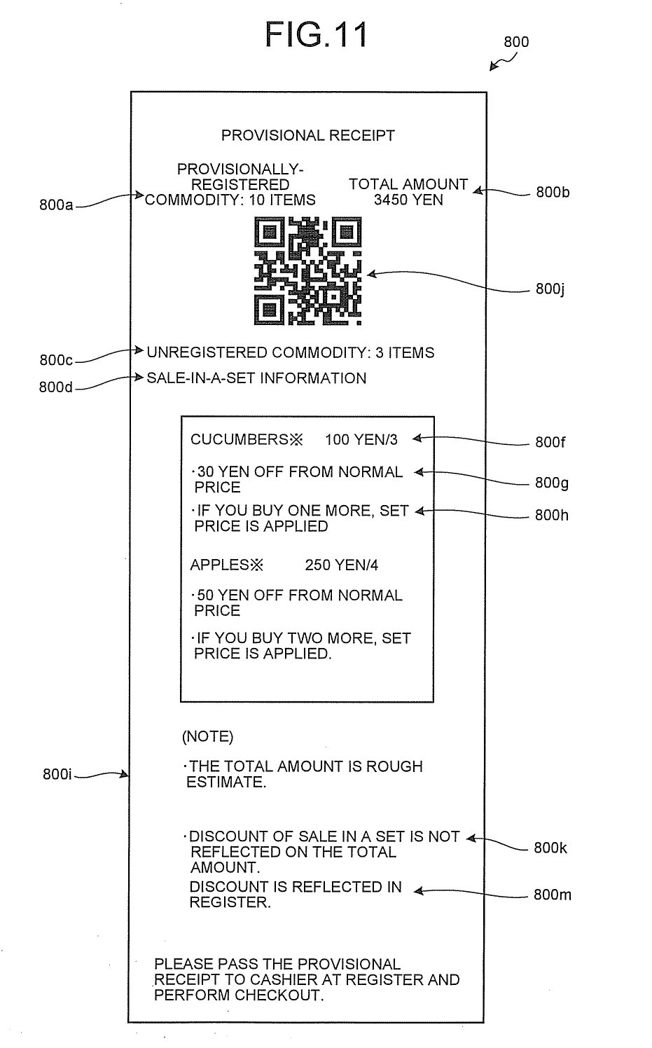

The commodity information processing system 1 is set in a store in which provisional registration and sale in a set of a commodity are performed. Before settlement of commodities of a customer waiting for settlement in each of the settlement apparatuses 300, the commodity information processing system 1 provisionally registers, with the portable terminal 100 operated by a store clerk, the commodities of the customer and issues, with the portable printer 200, a provisional receipt 800 (see FIG. 11) on which information concerning the provisionally registered commodities are displayed. When the settlement is performed, the customer passes the provisional receipt 800 to a cashier. The cashier who receives the provisional receipt 800 performs operation for inputting the information concerning the commodities displayed on the provisional receipt 800 to the settlement apparatus 300. Consequently, the settlement apparatus 300 performs the settlement of the commodities.

The sale in a set is a sales form for selling plural items of a commodity together in one transaction to, for example, grant a benefit to a customer as a target of the sale in a set. The benefit of the sale in a set is, for example, a discount for a target commodity of the sale in a set. A discount of a sales price is granted to a customer who purchases plural items of the target commodity of the sale in a set. In short, a sales price of a commodity sold in a set is lower than a total of unit prices of the number of items sold in a set of the target commodity of the sale in a set. In this case, sale in a set of a specified number of items of the target commodity is a condition for realizing sale. A kind of a target commodity in one sale in a set may be one kind or may be plural kinds. In an example explained below, the kind of the target commodity in one sale in a set is one kind and plural types of the sale in a set are set. For example, as first sale in a set, sale in a set of three cucumbers is set. As second sale in a set, sale in a set of four apples is set.

The units of the commodity information processing system 1 are explained in detail later.

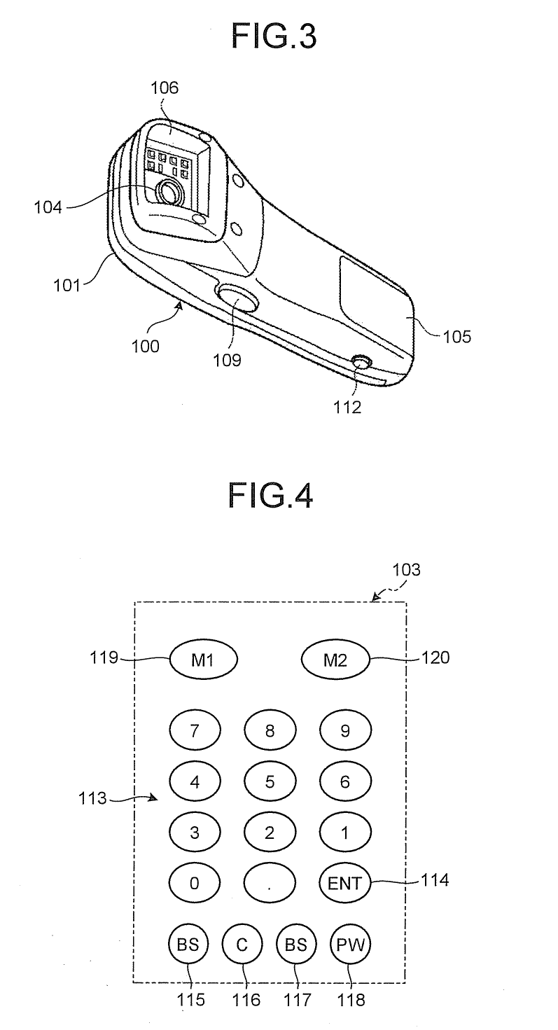

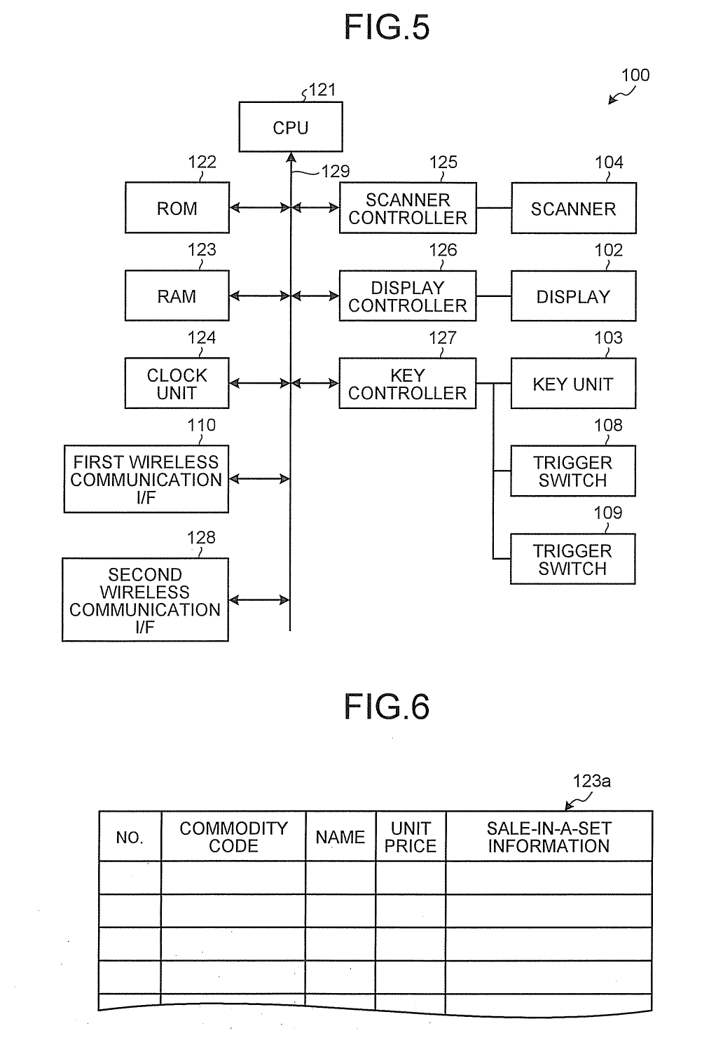

The portable terminal 100 is a portable information processing terminal operated by the store clerk or the like of the store and is configured as a computer. As shown in FIGS. 2 and 3, the portable terminal 100 is formed in a substantially rectangular parallelepiped shape in external appearance. The portable terminal 100 is configured to allow the store clerk carrying the portable terminal 100 to operate the same with one hand. The portable terminal 100 includes a display 102 such as a liquid crystal display and a key unit 103 on the front surface of a housing 101. The portable terminal 100 includes a scanner 104, which is a reading unit and a second reading unit, and a battery 105 on the rear surface of the housing 101. A code reading opening 106 of the scanner 104 is formed on the rear surface of the housing 101. The portable terminal 100 includes trigger switches 108 and 109 in substantially the centers on both the left and right side surfaces of the housing 101. The trigger switches 108 and 109 are used as a trigger in reading a code symbol such as a barcode with the scanner 104. A light projecting and receiving window 111 of a first wireless communication interface 110 (see FIG. 5) is formed in a lower part on the left side surface of the housing 101.

The battery 105 is detachably attached to a lower part of the rear surface of the housing 101. When a release switch 112 provided in a lower part on the right side surface of the housing 101 is operated, the battery 105 is removed from the housing 101. The portable terminal 100 operates with electric power of the battery 105.

The key unit 103 includes, as shown in FIG. 4, a ten key 113 including number keys of “0” to “9” and a decimal point key, an enter key 114, a back space key 115, a clear key 116, a shift key 117, a power key 118, a first magic key 119, and a second magic key 120.

The scanner 104 optically reads barcodes attached to commodities. Commodity codes as commodity identification information are set for the commodities. The commodity codes are attached to the commodities in a form of the barcodes. The scanner 104 is provided separately from a CCD scanner 303 explained later provided in the settlement apparatus 300.

The portable terminal 100 includes, as shown in FIG. 5, a central processing unit (CPU) 121, a read only memory (ROM) 122, a random access memory (RAM) 123, and a clock unit 124 configured to measure data and time. The CPU 121, the ROM 122, the RAM 123, and the clock unit 124 are connected via a bus line 129 such as an address bus or a data bus and configure a control unit 150, which is a computer.

The CPU 121 executes computer-readable various computer programs stored in the ROM 122 to thereby control the portable terminal 100. The ROM 122 has stored therein the various computer programs to be executed by the CPU 121 and various data. The RAM 123 temporarily stores the various computer programs to be executed by the CPU 121 and rewritably stores the various data. A power supply for the RAM 123 is backed up by the battery 105. The data stored in the RAM 123 is maintained even if the power supply is turned off.

The portable terminal 100 further includes a scanner controller 125, a display controller 126, a key controller 127, a first wireless communication interface (in the figure, I/F) 110, and a second wireless communication interface (in the figure, I/F) 128. The scanner controller 125, the display controller 126, the key controller 127, the first wireless communication interface 110, and the second wireless communication interface 128 are connected to the CPU 121 by the bus line 129.

The scanner controller 125 captures a signal of data read by the scanner 104 and inputs the signal to the CPU 121. The display controller 126 controls driving of the display 102 and causes the display 102 to display characters or the like corresponding to display data given from the CPU 121. The key controller 127 captures signals output from the key unit 103 and the trigger switches 108 and 109 and notifies the CPU 121 of the signals.

The first wireless communication interface 110 controls wireless data communication with the portable printer 200. Wireless communication between the portable terminal 100 and the portable printer 200 maybe communication by a radio wave, light, an infrared ray, or ultrasound, proximity wireless communication (e.g., Bluetooth (registered trademark)), or the like. In this embodiment, an infrared ray is used.

The second wireless communication interface 128 controls wireless data communication with the wireless access point 500. The portable terminal 100 performs, with the first wireless communication interface 110, data communication with other apparatuses such as the store server 400 via the wireless access point 500. In this embodiment, the portable terminal 100 and the wireless access point 500 configure a wireless LAN system employing a wireless LAN scheme.

As shown in FIG. 6, a provisionally-registered commodity information storage area 123a is formed in the RAM 123. The provisionally-registered commodity information storage area 123a stores a commodity code, a commodity name, a unit price, sale-in-a-set information, and the like for each of commodities, commodity codes of which are read by the scanner 104. The provisionally-registered commodity information storage area 123a of the RAM 123 is a storing unit configured to store a commodity code read by the scanner 104. If a commodity, a commodity code of which is read by the scanner 104, is not a target commodity of sale in a set, sale-in-a-set information is not stored.

The portable printer 200 issues, for example, the provisional receipt 800 (FIG. 11) as an information display medium on which information is displayed. The portable printer 200 is, for example, a printer of a line thermal type that uses, as sheets, roll paper wound in a roll shape. The portable printer 200 prints, while drawing out the roll paper wound in the roll shape, information on the roll paper, generates the provisional receipt 800, cuts off the provisional receipt 800 from the roll paper, and issues the provisional receipt 800. The portable printer 200 includes a control unit (not shown) including a CPU, a ROM, and a RAM and a wireless communication interface (not shown) connected to the control unit. The portable printer 200 performs wireless data communication with the portable terminal 100 through the wireless communication interface.

The settlement apparatus 300 includes, as shown in FIG. 1, a point of sales (POS) terminal 301 as a computer, a barcode scanner 302 connected to the POS terminal 301, and a charge coupled device (CCD) scanner 303 as a first reading unit connected to the POS terminal 301.

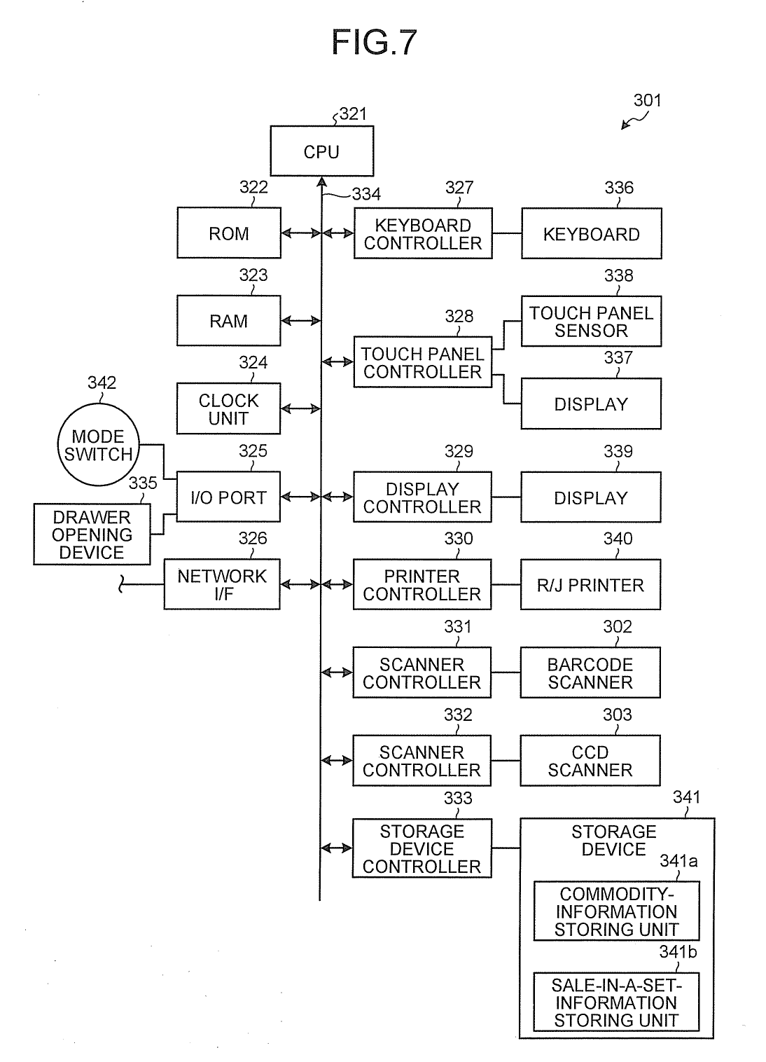

The POS terminal 301 includes, as shown in FIG. 7, a CPU 321, a ROM 322, a RAM 323, a clock unit 324, an input/output (I/O) port 325, a network interface 326, a keyboard controller 327, a touch panel controller 328, a display controller 329, a printer controller 330, scanner controllers 331 and 332, and a storage device controller 333. These devices are connected via a bus line 334 such as an address bus or a data bus.

The CPU 321 executes computer-readable various computer programs stored in the ROM 322 to thereby control the POS terminal 301. The ROM 322 has stored therein the various computer programs to be executed by the CPU 321 and various data. The RAM 323 stores the various computer programs to be executed by the CPU 321 and various data.

The clock unit 324 measures the present date and time. The network interface 326 controls data communication with other apparatuses connected through the wired communication network 700 or the like. The I/O port 325 receives input of a mode selection signal from a mode switch 342 and outputs a driving signal to a drawer opening device 335 configured to automatically open a drawer (not shown). The keyboard controller 327 captures a key signal corresponding to an operation key from a keyboard 336 and notifies the CPU 321 of the key signal. The touch panel controller 328 controls driving of a display with touch panel for customer 337 and causes the display with touch panel for customer 337 to display, in color, characters or the like corresponding to display data supplied from the CPU 321. The touch panel controller 328 captures a signal from the touch panel sensor 338 attached to a screen of the display 337 and notifies the CPU 321 of the signal. The display controller 329 controls driving of a display for operator 339 and causes the display for operator 339 to display, in color, characters or the like corresponding to display data given from the CPU 321. The printer controller 330 controls driving of a receipt and journal (in the figure, R/J) printer 340 and causes the receipt and journal printer 340 to perform receipt printing and journal printing on the basis of print data supplied from the CPU 321. The scanner controller 331 captures a signal of data read by the barcode scanner 302 and inputs the signal to the CPU 321. The scanner controller 332 captures a signal of data read by the CCD scanner 303 and inputs the signal to the CPU 321. The storage device controller 333 controls writing and readout of data in and from a storage device 341 on the basis of an instruction signal from the CPU 321.

The storage device 341 includes a hard disk drive device. The storage device 341 has stored therein, for example, a computer program for causing the CPU 321 to operate. The storage device 341 includes a commodity-information storing unit 341a configured to store commodity data that indicates various kinds of information concerning commodities and a sale-in-a-set-information storing unit 341b having stored therein sale-in-a-sets information. The commodity data stored in the commodity-information storing unit 341a is a copy of commodity data stored in the store server 400 explained later. The commodity data includes commodity codes, commodity names, and unit prices of commodities. The sale-in-a-set information stored in the sale-in-a-set-information storing unit 341b is a copy of sale-in-a-set information stored in the store server 400 explained later. The sale-in-a-set information includes, for each type of sale in a set, for example, sale-in-a-set identification information as identification information concerning the sale in a set, a name of a target commodity of the sale in a set, information concerning a condition for realizing the sale in a set, and information concerning a benefit of the sale in a set.

The barcode scanner 302 optically reads a barcode attached to a commodity. The CCD scanner 303 optically reads a two-dimensional code and the like.

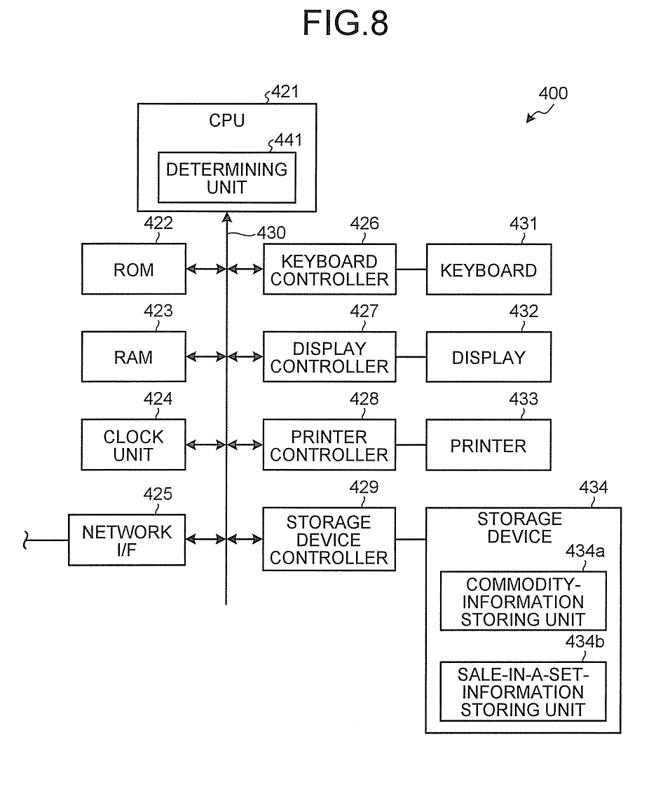

The store server 400 includes, as shown in FIG. 8, a CPU 421, a ROM 422, a RAM 423, a clock unit 424, a network interface (in the figure, I/F) 425, a keyboard controller 426, a display controller 427, a printer controller 428, and a storage device controller 429. These devices are connected via a bus line 430 such as an address bus or a data bus.

The CPU 421 executes computer-readable various computer programs stored in the ROM 422 to thereby control the store server 400. The ROM 422 has stored therein the various computer programs to be executed by the CPU 421 and various data. The RAM 423 stores the various computer programs to be executed by the CPU 421 and various data.

The clock unit 424 measures the present date and time. The network interface 425 controls data communication with other apparatuses connected through a wired communication network 700 or the like. The store server 400 is enabled to perform data communication with the portable terminal 100 and the POS terminal 301 of the settlement apparatus 300 by the wired communication network 700. The keyboard controller 426 captures a key signal corresponding to an operation key from a keyboard 431 and notifies the CPU 421 of the key signal. The display controller 427 controls driving of a display 432 and causes the display 432 to display, in color, characters or the like corresponding to display data given from the CPU 421. The printer controller 428 controls driving of a printer 433 and causes the printer 433 to perform printing on a sheet on the basis of print data supplied from the CPU 421. The storage device controller 429 controls writing and readout of data in and from a storage device 434 on the basis of an instruction signal from the CPU 421.

The storage device 434 includes a hard disk drive device. The storage device 434 has stored therein, for example, a computer program for causing the CPU 421 to operate. The storage device 434 includes a commodity-information storing unit 434a as a second storing unit configured to store commodity data that indicates various kinds of information concerning commodities and a sale-in-a-set-information storing unit 434b as a first storing unit having stored therein sale-in-a-sets information. The commodity-information storing unit 434a has stored therein commodity information including names and unit prices of commodities in association with commodity codes, which are commodity identification information. The sale-in-a-set information includes, for each type of sale in a set, for example, sale-in-a-set identification information as identification information concerning sale in a set, names of target commodities of the sale in a set, a condition for realizing the sale in a set, and information concerning a benefit of the sale in a set.

The wireless access point 500 is a wireless communication apparatus for connecting an apparatus (e.g., the store server 400) connected to the wired communication network 700 and the portable terminal 100. The wireless access point 500 performs protocol conversion between a wireless LAN and a wired LAN. The wireless access point 500 can be configured as, for example, a computer including a control unit including a CPU, a ROM, a RAM, a network interface, and a wireless communication interface.

Among the various kinds of processing executed by the CPU 121 of the portable terminal 100, the CPU 321 of the POS terminal 301, and the CPU 421 of the store server 400 of the commodity information processing system 1 according to computer programs, provisional registration processing and checkout processing are explained.

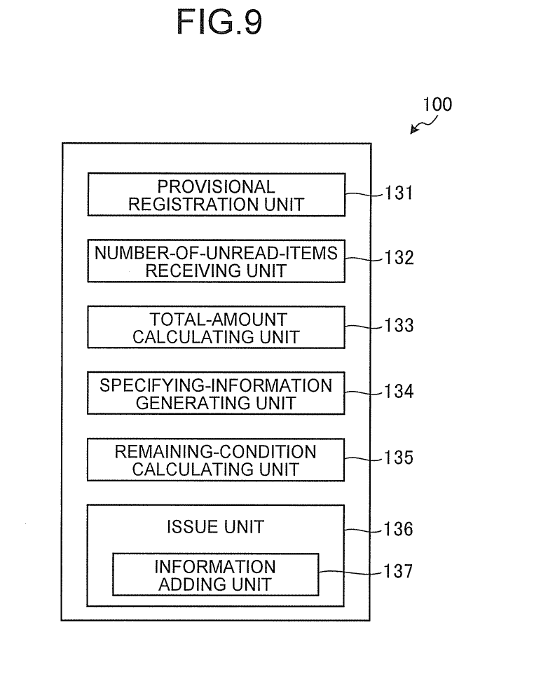

First, the provisional registration processing is explained. The portable terminal 100 and the store server 400 execute the provisional registration processing. The CPU 121 of the portable terminal 100 realizes, according to computer programs, a provisional registration unit 131, a number-of-unread-items receiving unit 132, a total-amount calculating unit 133, a specifying-information generating unit 134, a remaining-condition calculating unit 135, an issue unit 136, and an information adding unit 137 included in the issue unit 136 as functional units as shown in FIG. 9. The functional units are included in the portable terminal 100. The CPU 421 of the store server 400 realizes a determining unit 441 as a functional unit according to a computer program as shown in FIG. 8. These units are explained below.

The provisional registration unit 131 functions as provisional registration means and storage control means. The provisional registration unit 131 provisionally registers a commodity, a commodity code of which is read by the scanner 104. Specifically, the provisional registration unit 131 detects a commodity code from information concerning a barcode input from the scanner 104 and causes the provisionally-registered commodity information storage area 123a of the RAM 123 to store the detected commodity code to provisionally register the commodity. The provisional registration unit 131 reads out a unit price of the commodity, the commodity code of which is read by the scanner 104, from the commodity-information storing unit 434a of the store server 400 as a second storing unit and causes the provisionally-registered commodity information storage area 123a to store the read-out unit price of the commodity. In the readout of the unit price of the commodity, the provisional registration unit 131 transmits a signal for requesting commodity information including the unit price and a name of the commodity to the store server 400, receives the commodity information transmitted from the store server 400 as a response to the request, and detects the unit price of the commodity from the received commodity information. The provisional registration unit 131 performs provisional registration of the commodity every time a barcode including a commodity code is input from the scanner 104 and causes the provisionally-registered commodity information storage area 123a to store commodity codes with numbers allocated to the commodity codes in order of the input from the scanner 104. In this case, in the store server 400, the determining unit 441 executes sale-in-a-set determination processing.

The determining unit 441 functions as determining means. The determining unit 441 searches through the sale-in-a-set-information storing unit 434b of the storage device 434 for the commodity code read by the scanner 104 and determines whether the commodity, the commodity code of which is read by the scanner 104, is a target commodity of sale in a set. Specifically, the determining unit 441 searches through the sale-in-a-set-information storing unit 434b of the storage device 434 for the commodity code transmitted from the portable terminal 100 by the provisional registration unit 131. If the commodity code is present in the sale-in-a-set-information storing unit 434b, the determining unit 441 determines that the commodity is a target commodity of the sale in a set. If the commodity code is not present in the sale-in-a-set-information storing unit 434b, the determining unit 441 determines that the commodity is not a target commodity of the sale in a set. The determining unit 441 transmits a determination result to the portable terminal 100. If the determining unit 441 determines that the commodity is a target commodity of the sale in a set, the determining unit 441 also transmits sale-in-a-set information of the sale in a set stored in the sale-in-a-set-information storing unit 434b to the portable terminal 100. The provisional registration unit 131 causes the provisionally-registered commodity information storage area 123a of the RAM 123 of the portable terminal 100 to store the sale-in-a-set information in association with the commodity code. In other words, if information corresponding to the commodity code read by the scanner 104, which is information concerning a condition for realizing sale in a set for granting a benefit by selling plural items of a commodity together in one transaction, is present, the provisional registration unit 131 causes the provisionally-registered commodity information storage area 123a of the RAM 123 to store the information concerning the condition for realizing the sale in a set. In other words, the provisional registration unit 131 operates as a storage control unit.

The number-of-unread-items receiving unit 132 functions as number-of-unread-items receiving means. The number-of-unread-items receiving unit 132 receives input of the number of items of a commodity, a barcode including a commodity code of which is not read by the scanner 104. Specifically, after the provisional registration of the commodity by the provisional registration unit 131 ends, the number-of-unread-items receiving unit 132 displays a number-of-unread-items input screen (not shown) on the display 102 and receives input of the number of unread items according to input operation of the ten key 113 and the like of the key unit 103. The number-of-unread-items receiving unit 132 receives the number of unread items input by the input operation of the ten key 113 and the like of the key unit 103 and causes the RAM 123 as a storing unit to store the received number of unread items.

The total-amount calculating unit 133 calculates a total amount of the commodity provisionally registered by the provisional registration unit 131, i.e., a total amount of the commodity, the commodity code of which is read by the scanner 104, using the unit price read out by the provisional registration unit 131. The total-amount calculating unit 133 does not reflect a discount, which is a benefit, on the total amount. Therefore, even if sale in a set is realized in one transaction, a discount of the sale in a set is not reflected on the total amount of the commodity calculated by the total-amount calculating unit 133. In other words, the total amount of the commodity calculated by the total-amount calculating unit 133 is a rough estimate value of a total sales price of the commodity.

The specifying-information generating unit 134 functions as specifying-information generating means and converting means. The specifying-information generating unit 134 generates a provisionally registered commodity specifying information for specifying the commodity provisionally registered by the provisional registration unit 131. In other words, the specifying-information generating unit 134 generates provisionally-registered commodity specifying information for specifying the commodity, the commodity code as commodity specifying information of which is read by the scanner 104. Specifically, the specifying-information generating unit 134 generates provisionally-registered commodity specifying information including commodity codes of all commodities, commodity codes of which are read by the scanner 104. The specifying-information generating unit 134 converts the provisionally-registered commodity specifying information including the plural commodity codes into pieces of information of different formats. In other words, the specifying-information generating unit 134 operates as a converting unit. Specifically, the specifying-information generating unit 134 converts the provisionally-registered commodity specifying information into code symbol data. The specifying-information generating unit 134 converts the provisionally-registered commodity specifying information into code symbol data on the basis of, for example, rules for specifying the shape and the like of a two-dimensional code, which is a code symbol.

The remaining-condition calculating unit 135 functions as remaining-condition calculating means. The remaining-condition calculating unit 135 determines whether a condition for realizing sale in a set targeting the commodity in one transaction is satisfied. If the remaining-condition calculating unit 135 determines that the condition for realizing the sale in a set is not satisfied, the remaining-condition calculating unit 135 calculates a remaining condition for satisfying the condition for realizing the sale in a set. Specifically, if there is a commodity determined as a target commodity of sale in a set by the determining unit 441, after the provisional registration of the commodity by the provisional registration unit 131 ends, the remaining-condition calculating unit 135 determines, using the content of the provisionally-registered commodity information storage area 123a of the RAM 123, whether the condition for realizing the sale in a set targeting the commodity in one transaction is satisfied. For example, if there is a target commodity of first sale in a set in the provisionally-registered commodity information storage area 123a of the RAM 123, the remaining-condition calculating unit 135 calculates the number of items of the target commodity (hereinafter referred to as number of items of target commodity) and compares the number of items of target commodity and a specified number of items (e.g., three), which is a condition for realizing the first sale in a set. If the number of items of target commodity is smaller, the remaining-condition calculating unit 135 determines that the condition for realizing the sale in a set is not satisfied. In this case, the remaining-condition calculating unit 135 calculates a number of items obtained by subtracting the number of items of target commodity from the specified number of items (e.g., three), which is the condition for realizing the first sale in a set. The remaining-condition calculating unit 135 causes the RAM 123 to store, as the remaining condition for satisfying the condition for realizing the sale in a set, the calculated number of items of the commodity in association with sale-in-a-set identification information. On the other hand, if the number of items of target commodity and the specified number of items, which is the condition for realizing the first sale in a set, are the same, the remaining-condition calculating unit 135 determines that the condition for realizing the sale in a set is satisfied.

If the number of items of target commodity is larger than the specified number of items, which is the condition for realizing the sale in a set, a part of the plural items of target commodity satisfies the condition for realizing the sale in a set and the remaining items of the target commodity does not satisfy the condition for realizing the sales in a set. Therefore, if the number of items of target commodity is larger than the specified number of items, which is the condition for realizing the sale in a set, the remaining-condition calculating unit 135 determines that a part of the items of the target commodity does not satisfy the condition for realizing the sale in a set. In this case, the remaining-condition calculating unit 135 divides the number of items of target commodity by the specified number of items (e.g., three), which is the condition for realizing the first sale in a set, to calculate the number of items as the remainder in the division. The remaining-condition calculating unit 135 causes the RAM 123 to store, as information concerning the remaining condition for all the items of the target commodity to satisfy the condition for realizing the sale in a set, the calculated number of items as the remainder of the commodity in association with the sale-in-a-set identification information. In this case, the remaining-condition calculating unit 135 adds identification information indicating that the part of the items of the target commodity satisfies the condition for realizing the sale in a set to the information concerning the remaining condition and causes the RAM 123 to store the information concerning the remaining condition.

The issue unit 136 functions as issue means. The issue unit 136 causes the portable printer 200 to issue the provisional receipt 800 on which the provisionally registered commodity specifying information generated by the specifying information generating unit 134 is displayed. The provisional receipt 800 is shown in FIG. 11. On the provisional receipt 800, provisionally-registered commodity specifying information 800j is displayed in a form of a two-dimensional code.

As shown in FIG. 11, the issue unit 136 displays, on the provisional receipt 800, a total amount 800b calculated by the total-amount calculating unit 133, information 800i indicating that the total amount is a rough estimate, information 800k indicating that a discount is not reflected on the total amount, and information 800m indicating that the discount is reflected by the settlement apparatus 300 by printing the pieces of information with the portable printer 200. In FIG. 11, as an example of the information 800i indicating that the total amount is a rough estimate, “the total amount is a rough estimate” is shown. In FIG. 11, as an example of the information 800k indicating that a discount is not reflected on the total amount, “a discount of sale in a set is not reflected on the total amount” is shown. In FIG. 11, as an example of the information 800m indicating that the discount is reflected by the settlement apparatus 300, “the discount is reflected in the register” is shown. The issue unit 136 displays, on the provisional receipt 800, the number of items 800a of he commodity which is registered provisionally by the provisional registration unit 131 and the number of items 800c of the commodity, input of which is received by the number-of-unread-items receiving unit 132, by printing the numbers with the portable printer 200.

The information adding unit 137 functions as information adding means. If the determining unit 441 determines that the commodity, the commodity code of which is read by the scanner 104, is a target commodity of sale in a set, the information adding unit 137 adds sale-in-a-set information 800d including the commodity as a target commodity and stored in the sale-in-a-set-information storing unit 434b to the provisional receipt 800. Specifically, the information adding unit 137 adds, as a part of sale-in-a-set information, the condition for realizing the sale in a set stored by the sale-in-a-set-information storing unit 434b, which is the condition for realizing the sale in a set transmitted by the determining unit 441 of the store server 400 and stored in the provisionally-registered commodity information storage area 123a of the RAM 123, by printing the condition for realizing the sale in a set on the provisional receipt 800 with the portable printer 200. As shown in FIG. 11, a condition for realizing the sale in a set 800f is displayed on the provisional receipt 800 as a part of the sale-in-a-set information 800d. The information adding unit 137 displays information 800g concerning a benefit of the sale in a set on the provisional receipt 800 as a part of the sale-in-a-set information 800d. Content of the sale-in-a-set information displayed on the provisional receipt 800 by the information adding unit 137 may be all pieces of sale-in-a-set information of certain sale in a set or may be apart of the pieces of sale-in-a-set information. However, the content desirably includes a condition for realizing the sale in a set.

The information adding unit 137 adds indication 800h of the remaining condition calculated by the remaining-condition calculating unit 135 to the provisional receipt 800 using the portable printer 200. Specifically, the information adding unit 137 adds, using the remaining condition stored in the RAM 123, indication of the remaining condition to the provisional receipt 800 by printing the indication with the portable printer 200.

If commodities of different types of sale in a set as targets are included in plural commodities, commodity codes of which are read by the scanner 104, the information adding unit 137 arranges the condition for realizing the sale in a set in order of reading of the commodity codes by the scanner 104 and displays the commodities on the provisional receipt 800 using the portable printer 200. In FIG. 11, as examples of the commodities in different types of sale in a set as targets, “cucumbers” and “apples” are displayed. In this example, a commodity code of “cucumbers” is read by the scanner 104 earlier than that of “apples”. Specifically, the information adding unit 137 arranges conditions for realizing the types of sale in a set in order of the numbers of the provisionally-registered commodity information storage area 123a of the RAM 123. In this case, the information adding unit 137 searches through the provisionally-registered commodity information storage area 123a of the RAM 123 in the order of numbers and does not adopt, for ranking of an array, the second and subsequent types of sale in a set among the conditions for realizing the same sale in a set.

In this way, if the determining unit 441 determines that the commodity, the commodity code of which is read by the scanner 104, is the target commodity of the sale in a set, the issue unit 136 including the information adding unit 137 causes the portable printer 200 to issue the provisional receipt 800 on which the sale-in-a-set information including the commodity as the target commodity and stored in the sale-in-a-set-information storing unit 434b and the provisionally-registered commodity specifying information are displayed. In other words, the issue unit 136 outputs, at least the plural commodity codes converted into the code symbol data by the specifying-information generating unit 134 and the information concerning the condition for realizing the sale in a set. The issue unit 136 operates as an output unit.

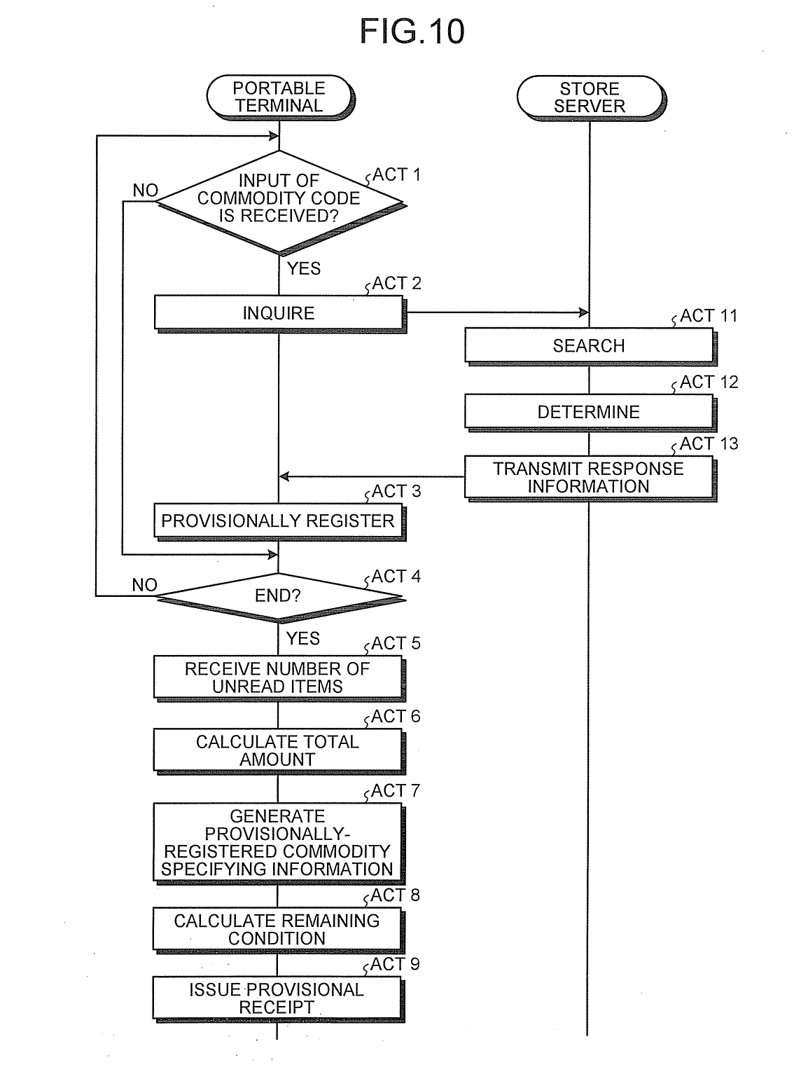

A flow of the provisional registration processing is explained with reference to a flowchart of FIG. 10. The CPU 121 of the portable terminal 100 waits for a commodity code to be input by the scanner 104 (No in Act 1 and No in Act 4). If a commodity code is input by the scanner 104, the CPU 121 receives the commodity code (Yes in Act 1) and proceeds to Act 2.

In Act 2, the CPU 121 operates as the provisional registration unit 131, inquires of the store server 400 about commodity information of a commodity, the commodity code of which is received in Act 1, and inquires of the store server 400 whether the commodity is a target commodity of sale in a set (Act 2).

In the store server 400 that receives the inquiry from the portable terminal 100, the CPU 421 searches through the commodity-information storing unit 434a for the commodity code of the commodity inquired by the CPU 121 and obtains commodity information including a name and a unit price of the commodity (Act 11). Subsequently, the CPU 421 operates as the determining unit 441, searches through the sale-in-a-set-information storing unit 434b for the commodity code of the commodity inquired by the CPU 121, and determines whether the commodity is a target commodity of sale in a set (Act 12). The CPU 421 transmits the commodity information of the commodity inquired by the CPU 121 and a determination result concerning whether the commodity is a target commodity of sale in a set to the portable terminal 100 as response information (Act 13).

In the portable terminal 100 that receives the response information from the store server 400, the CPU 121 operating as the provisional registration unit 131 provisionally registers the commodity, the commodity code of which is received in Act 1 (Act 3). If the end of the provisional registration of the commodity is not declared according to operation of a predetermined key of the key unit 103 (No in Act 4), the CPU 121 performs the processing in Acts 1 and 2 every time a commodity code is input by the scanner 104. If the end of the provisional registration of the commodity is declared according to operation of the predetermined key of the key unit 103 (Yes in Act 4), the CPU 121 ends the provisional registration of the commodity and proceeds to Act 5.

In Act 5, the CPU 121 operates as the number-of-unread-items receiving unit 132, receives input of the number of items of a commodity, a barcode including a commodity code of which is not read by the scanner 104, and causes the RAM 123 to store the number of items of the commodity.

Subsequently, the CPU 121 operates as the total-amount calculating unit 133 and calculates, without applying a discount, a total amount of all the items of the commodity provisionally registered by the provisional registration unit 131 at a unit price read out by the provisional registration unit 131 in Act 1 (Act 6).

The CPU 121 operates as the specifying-information generating unit 134 and generates provisionally-registered-commodity specifying information for specifying the commodity provisionally registered by the provisional registration unit 131 (Act 7).

The CPU 121 operates as the remaining-condition calculating unit 135 and determines whether a condition for realizing sale in a set targeting the commodity in one transaction is satisfied. If the CPU 121 determines that the condition for realizing the sale in a set is not satisfied, the CPU 121 calculates the remaining condition for satisfying the condition for realizing the sale in a set (Act 8).

The CPU 121 operates as the issue unit 136 and causes the portable printer 200 to issue the provisional receipt 800 (Act 9). If there is a target commodity of sale in a set in commodities, commodity codes of which are read by the scanner 104 in Act 12, the CPU 121 also operates as the information adding unit 137 and adds, for example, information concerning the sale in a set including the commodity as the target commodity and indication of the remaining condition calculated by the remaining-condition calculating unit 135 to the provisional receipt 800. If there is no sale-in-a-set target commodity, the issue unit 136 does not display information concerning sale in a set on the provisional receipt 800.

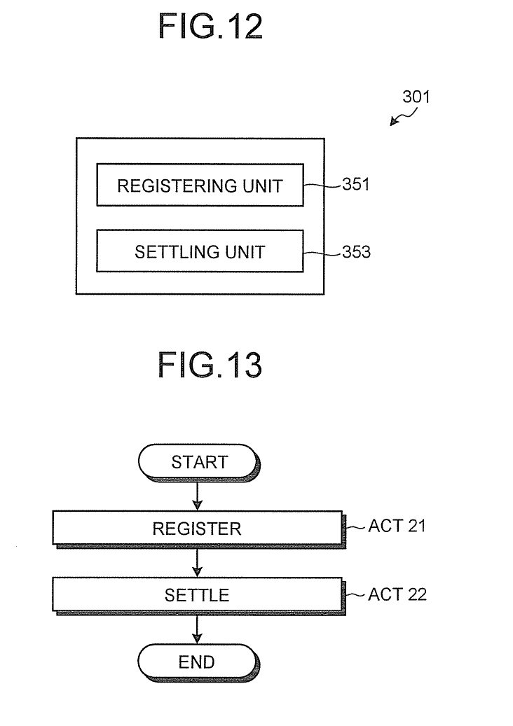

The checkout processing performed by the CPU 321 of the POS terminal 301 is explained below. The CPU 321 realizes, according to a computer program, a registering unit 351 and a settling unit 353 as functional units as shown in FIG. 12.

The checkout processing is explained below with reference to FIG. 13. As shown in FIG. 13, first, the CPU 321 operates as the registering unit 351 and registers a commodity, a commodity code of which is input from the CCD scanner 303 or the barcode scanner 302 (Act 21). Specifically, the CPU 321 reads out commodity information (a name, a unit price, etc.) of the commodity, the commodity code of which is received, from the commodity-information storing unit 341a and generates sales data including the commodity code, the commodity name, and the unit price using the read-out commodity information. The CPU 321 causes a storing unit such as the RAM 323 to store the generated sales data to register the commodity. The CCD scanner 303 reads, according to operation by a store clerk, the provisionally-registered commodity specifying information 800j displayed in a form of a two-dimensional code on the provisional receipt 800 and inputs the read information to the POS terminal 301. The barcode scanner 302 reads, according to operation by the store clerk, a commodity code displayed in a form of a barcode on a commodity not provisionally registered by the portable terminal 100 and inputs the read commodity code to the POS terminal 301. If plural commodity codes are included in the provisionally-registered commodity specifying information 800j, the CPU 321 generates sales data for each of the commodity codes and registers a commodity.

Subsequently, the CPU 321 operates as the settling unit 353 and performs settlement for the commodity registered in Act 21 (Act 22). For example, when a closing key of the keyboard 336 is depressed, the CPU 321 calculates a total sales price of the registered commodity and causes the displays 337 and 339 to display the total sales price. The CPU 321 determines, using the sale-in-a-set-information storing unit 341b, whether sales in a set is realized by the commodity registered in Act 21. A method for the determination is the same as the determination method performed by the determining unit 441 of the store server 400. If the sale in a set is realized, the settling unit 353 calculates a (discounted) total sales price on which a discount amount of the sale in a set is reflected. The store server 400 may perform the calculation of a total sale price. When input of a deposit amount equal to or larger than the total sales price is performed through the keyboard 336 according to operation by the store clerk, the CPU 321 receives the input amount to perform settlement of the commodity. In this way, the settling unit 353 applies settlement to the commodity specified by the provisionally-registered commodity specifying information displayed on the provisional receipt 800 read by the CCD scanner 303. The CPU 321 issues, with the receipt and journal printer 340, a receipt on which predetermined content including sales data is displayed. The CPU 321 generates journal data related to one transaction including the total sales price and the like, records the generated journal data on a journal sheet with the receipt and journal printer 340, and opens the drawer.

As explained above, in this embodiment, if the determining unit 441 of the store server 400 determines that a commodity, a commodity code of which is read by the scanner 104 of the portable terminal 100, is a target commodity of sale in a set, the information adding unit 137 adds indication of a condition for realizing the sale in a set targeting the commodity as a target commodity to the provisional receipt 800. Therefore, if a commodity that a customer plans to purchase is a target commodity of sale in a set, it is possible to cause the customer to recognize information concerning the sale in a set before settlement. Therefore, it is possible to realize sales promotion for the commodity through the sale in a set.

In this embodiment, if the remaining-condition calculating unit 135 determines that the condition for realizing the sale in a set is not satisfied, the remaining-condition calculating unit 135 calculates the remaining condition for satisfying the condition for realizing the sale in a set. The information adding unit 137 adds the indication 800h of the remaining condition to the provisional receipt 800. Therefore, it is possible to cause the customer to recognize the remaining condition for satisfying the condition for realizing the sale in a set.

In this embodiment, the issue unit 136 displays the total amount 800b calculated by the total-amount calculating unit 133 and the information 800i indicating that the total amount is a rough estimate on the provisional receipt 800 using the portable printer 200. Therefore, it is possible to prevent the customer from having a distrust concerning the fact that the discount of the sale in a set is not reflected on the total amount.

In this embodiment, the issue unit 136 displays the number of items 800c of the commodity, the input of which is received by the number-of-unread-items receiving unit 132, on the provisional receipt 800 using the portable printer 200. Therefore, the store clerk who performs checkout can grasp, looking at the provisional receipt 800, the number of items of the commodity not provisionally registered by the portable terminal 100.

### Second Embodiment

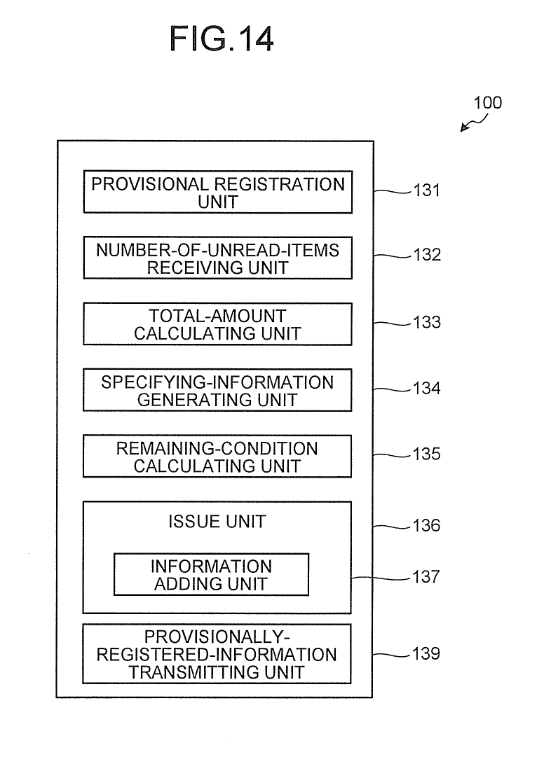

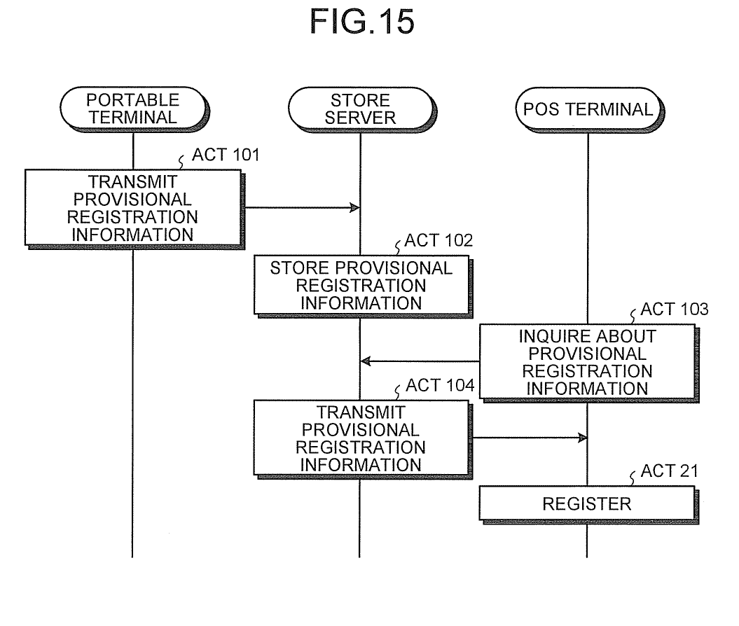

A second embodiment is explained below with reference to FIGS. 14 and 15.

This embodiment is different from the first embodiment in that, in the commodity information processing system 1, information concerning a commodity provisionally registered by the portable terminal 100 is directly transmitted to the POS terminal 301 via the store server 400 without converting the information into a code symbol.

In this embodiment, the CPU 121 of the portable terminal 100 realizes, according to a computer program, a provisionally-registered-information transmitting unit 139 as a functional unit in addition to the provisional registration unit 131, the number-of-unread-items receiving unit 132, the total-amount calculating unit 133, the specifying-information generating unit 134, the remaining-condition calculating unit 135, the issue unit 136, and the information adding unit 137 included in the issue unit 136 as shown in FIG. 14.

In this embodiment, provisionally-registered commodity specifying information generated by the specific-information generating unit 134 is information different from commodity identification information given in each transaction. The provisionally-registered commodity specifying information is, for example, a number.

Operations performed by the commodity information processing system 1 are explained below with reference to FIG. 15. First, in the portable terminal 100, the provisionally-registered-information transmitting unit 139 transmits provisional registration information in which a commodity code, which is commodity identification information of a commodity provisionally registered by the provisional registration unit 131, and provisionally-registered commodity specifying information are associated to the store server 400 (Act 101).

The store server 400 stores the provisional registration information transmitted by the provisionally-registered-information transmitting unit 139 in the storage device 434 as a third storing unit (Act 102).

In the POS terminal 301, in checkout processing, the registering unit 351 inquires of the store server 400 about a commodity code stored in the storage device 434 of the store server 400 in association with provisionally-registered commodity specifying information read by the CCD scanner 303 (Act 103).

The store server 400 that receives the inquiry from the POS terminal 301 searches through the storage device 434 for the inquired provisionally-registered commodity specifying information, obtains provisional registration information including the provisionally-registered commodity specifying information, and transmits the provisional registration information to the POS terminal 301 as response information (Act 104).

In the POS terminal 301, the registering unit 351 receives the provisional registration information from the store server 400. In this embodiment, the registering unit 351 functions as reading means for reading out commodity identification information stored in the storage device 434 in association with the provisionally-registered commodity specifying information read by the CCD scanner 303. Subsequently, in the POS terminal 301, the registering unit 351 registers a commodity, a commodity code of which is included in the provisional registration information (Act 21). In the POS terminal 301, the settling unit 353 applies settlement to the commodity, the commodity code of which is read out by the registering unit 351.

In this embodiment explained above, effects same as those in the first embodiment can be realized.

The present invention is not limited to the embodiments. Various other embodiments can be adopted without departing from the spirit of the present invention. For example, a determining unit as determining means and a sale-in-a-set-information storing unit may be provided in a portable terminal.

The benefit of sale in a set may be, for example, issuance of a gift certificate, a point that can be used instead of cash in a store, or a free offer of a commodity.

The information display medium may be, for example, a rewrite display medium on which printing and erasing of information can be performed according to thermal energy applied thereto.

The computer programs executed in the portable terminal, the POS terminal, the store server, and the like according to the embodiments may be provided while being recorded in a computer-readable recording medium such as a CD-ROM, a flexible disk (FD), a CD-R, or a DVD in a file of an installable format or an executable format.

The computer programs executed in the portable terminal, the POS terminal, the store server, and the like according to the embodiments may be provided by being stored on a computer connected to a network such as the Internet and downloaded through the network. The computer programs executed in the portable terminal, the POS terminal, the store server, and the like according to the embodiments may be provided or distributed through the network such as the Internet.

According to the embodiments, there is an effect that, in a provisional registration system, if a commodity that a customer plans to purchase is a target commodity of sale in a set, it is possible to cause the customer to recognize information concerning the sale in a set before settlement.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity information processing system comprising:
a second reading unit provided separately from a first reading unit, which is provided in a settlement apparatus, and configured to read commodity identification information attached to a commodity;
a medium issue unit configured to issue an information display medium on which information is displayed;
a first storing unit having stored therein sale-in-a-set information including commodity identification information concerning a target commodity in sale in a set for granting a benefit by selling plural items of a commodity together in one transaction, information concerning a condition for realizing the sale in a set, and information concerning the benefit;
a specifying information generating unit configured to generate provisionally-registered commodity specifying information for specifying the commodity, the commodity identification information of which is read by the second reading unit;
a determining unit configured to search through the first storing unit for the commodity identification information read by the second reading unit and determine whether the commodity, the commodity identification information of which is read, is a target commodity of the sale in a set; and
an issue unit configured to cause, if the determining unit determines that the commodity, the commodity identification information of which is read, is a target commodity of the sale in a set, the medium issue unit to issue the information display medium on which the sale-in-a-set information including the commodity as the target commodity and stored in the first storing unit and the provisionally-registered commodity specifying information are displayed.

2. The system according to claim 1, further comprising a remaining-condition calculating unit configured to determine, if there is a commodity determined as a target commodity of the sale in a set by the determining unit, whether a condition for realizing the sale in a set targeting the commodity in one transaction is satisfied and calculate, if the remaining-condition calculating unit determines that the condition for realizing the sale in a set is not satisfied, a remaining condition for satisfying the condition for realizing the sale in a set, wherein
the issue unit adds indication of the remaining condition to the information display medium.

3. The system according to claim 1, wherein the issue unit arranges, if commodities of different types of sale in a set as targets are included in plural commodities, commodity identification information of which are read by the second reading unit, the commodities in order of reading of the commodity identification information by the second reading unit and displays the commodities on the display medium using the medium issue unit.

4. The system according to claim 1, wherein
the benefit is a discount for a target commodity of the sale in a set, and
the system further comprises:
a readout unit configured to read out a unit price of the commodity, the commodity identification information of which is read by the second reading unit, from a second storing unit having stored therein commodity information including unit prices of commodities in association with commodity identification information; and
a total-amount calculating unit configured to calculate a total amount of the commodity, the commodity identification information of which is read by the second reading unit, at the unit price read out by the readout unit.

5. The system according to claim 4, wherein the issue unit displays, on the display medium, using the medium issue unit, the total amount calculated by the total-amount calculating unit and information indicating that a discount is not reflected on the total amount.

6. The system according to claim 4, wherein the issue unit displays, on the display medium, using the medium issue unit, information indicating that a discount is reflected by the settlement apparatus.

7. The system according to claim 1, further comprising a number-of-unread-items receiving unit configured to receive input of a number of items of a commodity, commodity identification information of which is not read by the second reading unit, wherein
the issue unit displays, on the display medium, using the medium issue unit, the number of items of the commodity, the input of which is received by the number-of-unread-items receiving unit.

8. The system according to claim 1, wherein the provisionally-registered commodity specifying information includes commodity identification information of all commodities, commodity identification information of which is read by the second reading unit.

9. A portable terminal comprising:
a reading unit configured to read commodity identification information attached to a commodity;
a storing unit configured to store the commodity identification information read by the reading unit;
a storage control unit configured to cause, if information corresponding to the commodity identification information read by the reading unit, which is information concerning a condition for realizing sale in a set for granting a benefit by selling plural items of a commodity together in one transaction, is present, the storing unit to store the information concerning the condition for realizing the sale in a set;
a converting unit configured to convert a plurality of pieces of the commodity identification information into pieces of information of different formats; and
an output unit configured to output at least the converted plural pieces of commodity identification information and the information concerning the condition for realizing the sale in a set.

10. The portable terminal according to claim 9, wherein
the benefit is a discount for a target commodity of the sale in a set, and
the storage control unit outputs information indicating that the discount is reflected by the settlement apparatus.

11. A commodity information processing method executed by a commodity information processing system including: a second reading unit provided separately from a first reading unit, which is provided in a settlement apparatus, and configured to read commodity identification information attached to a commodity; a medium issue unit configured to issue an information display medium on which information is displayed; and a first storing unit having stored therein sale-in-a-set information including commodity identification information concerning a target commodity in sale in a set for granting a benefit by selling plural items of a commodity together in one transaction, information concerning a condition for realizing the sale in a set, and information concerning the benefit,
the method comprising:
a specifying information generating unit generating provisionally-registered commodity specifying information for specifying the commodity, the commodity identification information of which is read by the second reading unit;
a determining unit searching through the first storing unit for the commodity identification information read by the second reading unit and determining whether the commodity, the commodity identification information of which is read, is a target commodity of the sale in a set; and
an issue unit causing, if the determining unit determines that the commodity, the commodity of which is read, is a target commodity of the sale in a set, the medium issue unit to issue the information display medium on which the sale-in-a-set information including the commodity as the target commodity and stored in the first storing unit and the provisionally-registered commodity specifying information are displayed.

12. A commodity information processing method executed by a portable terminal including: a reading unit configured to read commodity identification information attached to a commodity; and a storing unit configured to store the commodity identification information read by the reading unit,
the method comprising:
a storage control unit causing, if information corresponding to the commodity identification information read by the reading unit, which is information concerning a condition for realizing sale in a set for granting a benefit by selling plural items of a commodity together in one transaction, is present, the storing unit to store the information concerning the condition for realizing the sale in a set;
a converting unit converting a plurality of pieces of the commodity identification information read by the reading unit into pieces of information of different formats; and
an output unit outputting at least the converted plural pieces of commodity identification information and the information concerning the condition for realizing the sale in a set.
